(19) United States
(12) Patent Application Publication
(10) Pub. No.: US 2006/0065747 A1
(43) Pub. Date: Mar. 30, 2006

(54) Bankphone

(76) Inventor: Alexander Leites, Karmiel (IL)

Correspondence Address: LEITES ALEXANDER, HAGALIL STR. 2, P.O.B. 468, KARMIEL, 20101, IL

(21) Appl. No.: 10/950,294

(22) Filed: Sep. 27, 2004

(51) Int. Cl. G06K 19/06; G06K 5/00; G06K 19/00

(52) U.S. Cl. 235/493; 235/487; 235/380

(57) ABSTRACT

Every year millions of people travel abroad. They need to solve a problem of safe money transportation and feel comfortable and confident while traveling. Our invention, a united magnetic card for telephone communication and withdrawing money from ATM favors the comfort of a traveler, increases safe money keeping and gives an additional service of telephone communication.

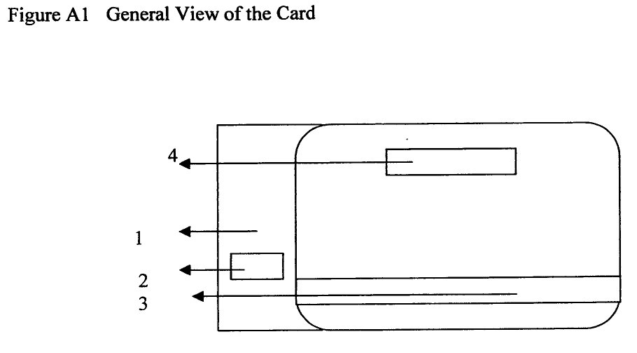

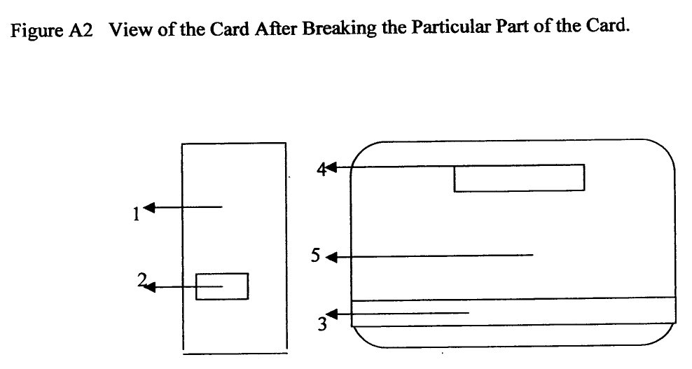

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

There are several known forms of magnetic cards that can be used for financial accompaniment and telephone communication by people going abroad.

Until today these forms worked separately from each other.

To the present moment we know the products of the following companies which are used as electronic substitutes of “travel checks”:
“Travel money” magnetic card of Visa International
“TravelFunds” magnetic card of American Express

There is also a great variety of telephone cards produced by many companies.

We know some disadvantages of the existing forms of cards used for money withdraw while traveling abroad. They are:
unlimited withdrawing of big amounts of money
The possibility of using the card after stealing or losing.
The difficulty in identification the purchaser of the card.

The person should also buy additional telephone cards and keep a large number of cards.

### BRIEF SUMMARY OF THE INVENTION

We have found the variant how to combine these two directions based on the existing analogues in the fields of telephone communication and safe money usage while traveling abroad—that is a united magnetic card that can be used for withdrawing the money from ATM machine and making phone calls.

In the case of the united “bankphone” card a purchaser has the following advantages:
The common card for withdrawing money and telephone calls.
Increasing combinability of the card that favors the comfort of the purchaser.
The “bankphone” card is the electronic substitute of the known today travel checks and telephone cards of the last generation in united form.
Limited amount of money: the maximal cost of each card is 300 $. It favors the safe money keeping while traveling abroad
Card delivery: the cards can be available not only in bank institutions but also in currency exchange offices all over the world.

### BRIEF DESCRIPTION OF THE SEVERAL VIEWS OF THE DRAWINGS

FIG. A1: General view of the card:
1. Breaking part of the card
2. Identity code for withdrawing money from ATM
3. Magnetic line
4. Secret number for telephone calls

FIG. A2: View of the card after breaking the particular part with an identity code
1. Breaking part of the card
2. Identity code for withdrawing money from ATM
3. Magnetic line
4. Secret number for telephone calls
5. The card after breaking the particular part with an identity code.

### DETAILED DESCRIPTION OF THE INVENTION

“Bankphone” card has analogy to the production process of production of known magnetic cards carried out according to the international standards and based on the known technologies.

The card contains magnetic line that allows to use the card in ATM machine.

We offer the innovation in the different form of the card which is the breaking part of the card that contains an identity code for ATM machine. This part must be broken and kept apart after purchasing the card.

The card is not used physically for telephone calls. It contains a secret number which is closed by opaque coating and removed by the purchaser. The purchaser dials the secret number and that allows him to carry out telephone calls.

What I claim as my invention is:

1. The idea of combining the card for withdrawing money and telephone card in one united card.

2. The idea of breaking the particular part of the card with a secret number used as an identity code for withdrawing money from ATM.

3. The name “bankphone” under which the card can be produced and sold.
